(19) United States
(12) Patent Application Publication
(10) Pub. No.: US 2019/0101003 A1
(43) Pub. Date: Apr. 4, 2019

(54) BLADES AND VANES FOR GAS TURBINE ENGINES AND THE MANUFACTURE THEREOF

(71) Applicant: ROLLS-ROYCE plc, London (GB)

(72) Inventor: Brynley CLARK, Derby (GB)

(73) Assignee: ROLLS-ROYCE plc, London (GB)

(21) Appl. No.: 16/110,174

(22) Filed: Aug. 23, 2018

(30) Foreign Application Priority Data
Sep. 29, 2017 (GB) 1715791.8

(51) Int. Cl. F01D 5/14; F01D 5/34; F01D 9/04

(52) U.S. Cl. CPC F01D 5/147; F01D 5/34; F01D 9/041; F05D 2250/61; F05D 2230/236; F05D 2240/12; F05D 2240/30; F05D 2230/50; F05D 2250/121; F05D 2220/32

(57) ABSTRACT

A method of forming a blade or vane for a gas turbine engine comprising: attaching a first outer layer to a first two-dimensional array of attachment areas on a first surface of an intermediate layer; attaching a second outer layer to a second two-dimensional array of attachment areas on a second surface of the intermediate layer opposite the first surface; and increasing a separation between at least a portion of the first and second outer layer to thereby deform the intermediate layer into a corrugated structure having corrugations in first and second directions.

### CROSS-REFERENCE TO RELATED APPLICATIONS

This application is based upon and claims the benefit of priority from British Patent Application Number 1715791.8 filed 29 Sep. 2017, the entire contents of which are incorporated by reference.

### BACKGROUND

### Technical Field

The present disclosure concerns blades and vanes for gas turbine engines, and methods of manufacturing blades and vanes for gas turbine engines.

### Description of the Related Art

Blades or vanes are used in gas turbine engines to redirect gas flow at various stages in the engine. Blades are generally provided on rotary components, such as the main fan, and on the compressor and turbine rotors, while vanes are generally provided on static components, such as inlet and outlet guides, and compressor and turbine stators. In use, these blades and vanes can vibrate, which can cause fatigue and damage the blades and vanes and other components of the engine. Therefore, it is generally desirable to reduce vibration in blades and vanes.

Vibration in blades and vanes can be reduced by providing viscous damping material in an internal cavity. However, forces within the engine can cause viscous material to shift within the blade or vane and thereby reduce the damping effectiveness, or even exacerbate the problem. In extreme cases, the hydrostatic pressure caused by the damping material being forced to the tip of a blade in use can cause the blade to burst and catastrophically fail. In addition, providing a cavity within a blade or vane can dramatically reduce its structural stiffness and strength.

Therefore, it will be understood that improvements in the area of damping blades and vanes are generally desirable.

### SUMMARY

According to a first aspect there is provided a method of forming a blade or vane for a gas turbine engine comprising: attaching a first outer layer to a first two-dimensional array of attachment areas on a first surface of an intermediate layer; attaching a second outer layer to a second two-dimensional array of attachment areas on a second surface of the intermediate layer opposite the first surface; and increasing a separation between at least a portion of the first and second outer layer to thereby deform the intermediate layer into a corrugated structure having corrugations in first and second directions.

The corrugated structure provides improved strength and stiffness of the blade or vane without adding significant weight to the blade. Furthermore, the corrugated structure can also prevent shifting of any damping material which may be provided within the blade. As the corrugated structure is formed simply by the increasing of the separation of the outer layers, it may be substantially self-forming after the attaching of the intermediate layer to the outer layers. As the corrugations are formed in two directions, the interconnectivity of the corrugations may be improved, such that filling of the blade with other materials may be made easier while also inhibiting shifting of filling material when the blade or vane is in use. Accordingly, manufacture of the internal structure of the blade or vane may be greatly simplified, thereby improving speed, ease, and cost of manufacture.

The blade or vane may be a blade or vane of a fan, a compressor, or a turbine of gas turbine engine. The vane could also be an inlet or outlet guide vane of a gas turbine engine.

Any of the first and second outer layers, and the intermediate layer may be formed from titanium. The layers may be bonded together by diffusion bonding. Yttrium may be applied to areas of the blade outside of the attachment areas to avoid diffusion bonding outside the attachment areas.

The first and second arrays of attachment areas are two-dimensional. In other words, the arrays may extend across the blade or vane in two-dimensions such that each attachment area is flanked by other attachment areas in two different directions. A two dimensional array may not include a plurality of parallel, or substantially parallel, line-shaped attachment areas which are spaced apart in a single column to form a ladder-like arrangement. Accordingly, corrugations in the corrugated structure will extend across the blade or vane in two directions. The first and second directions may be substantially perpendicular.

Increasing the separation between the first and second outer layers may comprise moving the first and second outer layers apart such that the first array of attachment areas move away from the second outer sheet and the second array of attachment areas move away from the first outer sheet.

The attachment areas of the first and second arrays may be substantially point-like. In other words, each attachment area may have a relatively small or negligible size compared to the dimensions of the blade or vane. The attachment areas may be substantially circular or oval-shaped. Each attachment area may have a substantially unattached area entirely encircling it such that a surface of a corrugation entirely surrounds each attachment area. A ratio of the attachment area diameter to a height of the corrugations may be around 1:4. This may provide a particularly effective corrugated structure for interconnectivity of the corrugations and structural integrity.

The first array of attachment areas and the second array of attachment areas may be non-overlapping in plan view. Accordingly, the corrugations of the corrugated structure may be formed at all attachment areas.

Each of the first array of attachment areas and the second array of attachment areas may be substantially equally spaced across the first and second surfaces of the intermediate layer. Accordingly, all of the corrugations of the corrugated structure may be substantially similar or identical.

Each of the first array of attachment areas and the second array of attachment areas may be are formed as a square array, a diamond array, a triangular array, a hexagonal array, or as an array of any other polygon.

One or more of the attachment areas of the first array of attachment areas may be arranged at the centre of a polygon, such as a square, defined by three or more of the second array of attachment areas. One or more of the attachment areas of the second array of attachment areas may be arranged at the centre of a polygon, such as a square, defined by three or more of the first array of attachment areas. One attachment area may be arranged at each vertex of the defined polygon. The defined polygons may be, for example, triangles, squares, rectangles, or hexagons

The method may further comprise filling an internal volume formed within the component with a filling material. The filling material may be a damping material, in particular a viscous damping material. The filling material may be a liquid or a gel, and may set into a flexible solid.

The internal volume may comprise a first volume formed between the first outer layer and the corrugated structure, and a second volume formed between the second outer later and the corrugated structure.

The intermediate layer may further comprise one or more apertures formed there through. The apertures may reduce the weight of the intermediate layer, and therefore of the blade or vane as a whole. The apertures may also provide communication between the first and second volumes for ease of filling with the filling material.

The one or more apertures have a size which is defined relative to a height of the corrugations of the corrugated structure. The size of an aperture may be a diameter or largest length across the aperture. In particular, the apertures may have a size which is less than or equal to about one half of the height of the corrugations of the corrugated structure, for example less than or equal to about one third of a height of the corrugations of the corrugated structure. The size of the aperture in a direction from an attachment area on the first surface and an adjacent (e.g. immediately adjacent except in a thickness direction) attachment area on the second surface, may be less than or equal to one half (e.g. less than or equal to one third) of a distance between said adjacent attachment areas on the first surface and the second surface. The apertures' size may be optimised to permit filling material to permeate the entire blade or vane, while also sufficiently inhibiting movement of the filling material during use of the blade or vane. The apertures may be substantially circular or ovoid prior to the deformation of the intermediate layer. The apertures may be formed approximately at the mid-points between adjacent attachment areas.

The filling may comprise filling one of the first and second volumes directly and filling the other of the first and second volumes from through the one or more apertures in the intermediate layer.

The first and second arrays of attachment areas are arranged such that the corrugations of the corrugated structure comprise alternating cone-like or dome-like structures having peaks formed at the attachment areas. Such structures may be particularly resistant to buckling and provide particularly good interconnectivity of the corrugations.

The first and second arrays of attachment areas may be arranged such that the corrugated structure has an egg-box-like shape.

The attaching steps may comprise diffusion bonding the first and second arrays of attachment areas to the first and second outer layers respectively.

The intermediate layer may be attached to the first and second outer layers about a periphery of the intermediate layer.

The intermediate layer may not attached to the first and second outer layers at any other location than the attachment areas, or the attachment areas and the periphery of the intermediate layer.

Increasing the separation between the first and second outer layers may comprise blow-moulding the blade or vane.

According to another aspect there is provided a method of manufacturing a gas turbine engine comprising forming a blade or vane using the method according to the previous aspect.

According to an aspect there is provided a blade or vane for a gas turbine engine comprising: a first outer layer; a second outer layer; and a corrugated structure formed between the first and second outer layers, the corrugated structure being attached to the first outer layer at a first two-dimensional array of attachment areas and attached to the second outer layer at a second two dimensional array of attachment areas such that corrugations of the corrugated structure extend in two directions.

The corrugations of the corrugated structure may comprise alternating cone-like or dome-like structures having peaks formed at the attachment areas.

The corrugated structure may have an egg-box-like shape.

The blade or vane may further comprise a filling material provided in an internal volume of the blade or vane between the first and second outer layers and the corrugated structure.

The corrugated structure may have one or more apertures formed there through.

According to a further aspect there is provided a rotor for a gas turbine engine comprising one or more blades of the previous aspect.

The rotor may be a bladed disc.

According to a further aspect there is provided a gas turbine engine comprising one or more blades of the previous aspect and/or one or more rotors of the previous aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2 is a schematic plan view of a blade or vane having partial transparency to show internal features of the blade or vane;

FIG. 3A is a cross sectional view of the blade or vane of FIG. 2 before a separation between at least a portion of the first and second outer layers is increased;

FIG. 3B is a cross sectional view of the blade or vane of FIG. 2 after a separation between at least a portion of the first and second outer layers is increased;

FIG. 3C is a cross sectional view of the blade or vane of FIG. 2 after filling with a damping material;

FIG. 4 is a cutaway perspective view of a portion of a corrugated structure; and

FIG. 5 is a cutaway perspective view of a portion of a blade or vane according to FIG. 3B.

### DETAILED DESCRIPTION

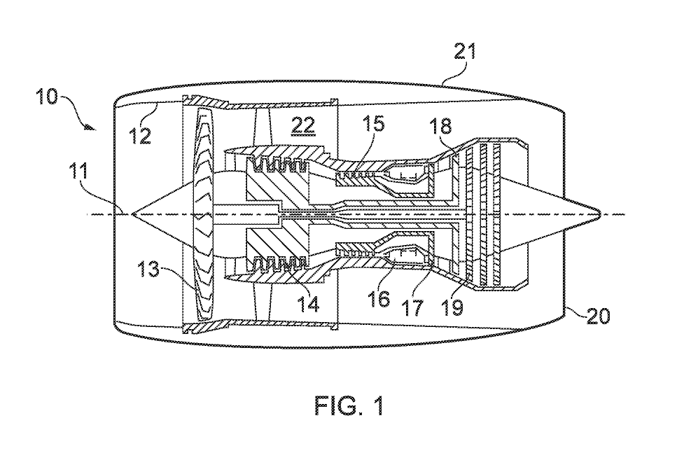

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

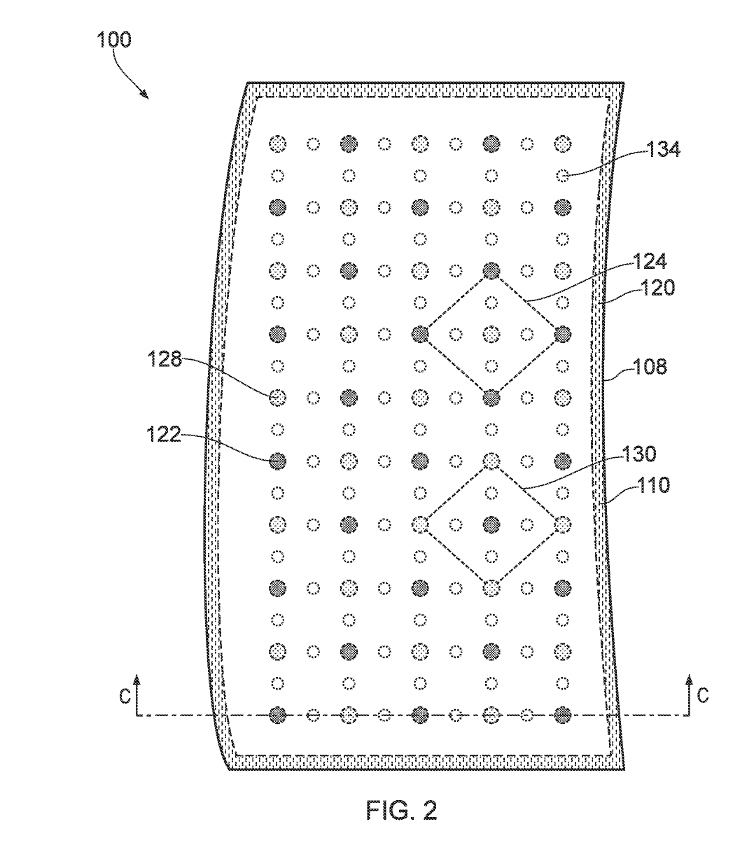

Referring now to FIG. 2, a blade or vane 100 is shown. The blade or vane 100 may be a blade or vane of the fan 13; of one of the compressors 14, 15; of one of the turbines 17, 18, 19; or of another part of the engine 10. For brevity, the remaining description will refer to blade 100 only, but it should be understood that this detailed description could equally refer to a vane.

Blade 100 is shown in schematic plan view in FIG. 1. FIG. 1 therefore shows a plan view of either the pressure surface or the suction surface of the blade 100. For illustrative purposes, various layers of the blade 100 have been depicted as partially transparent such that features within the blade 100 can be seen in FIG. 1.

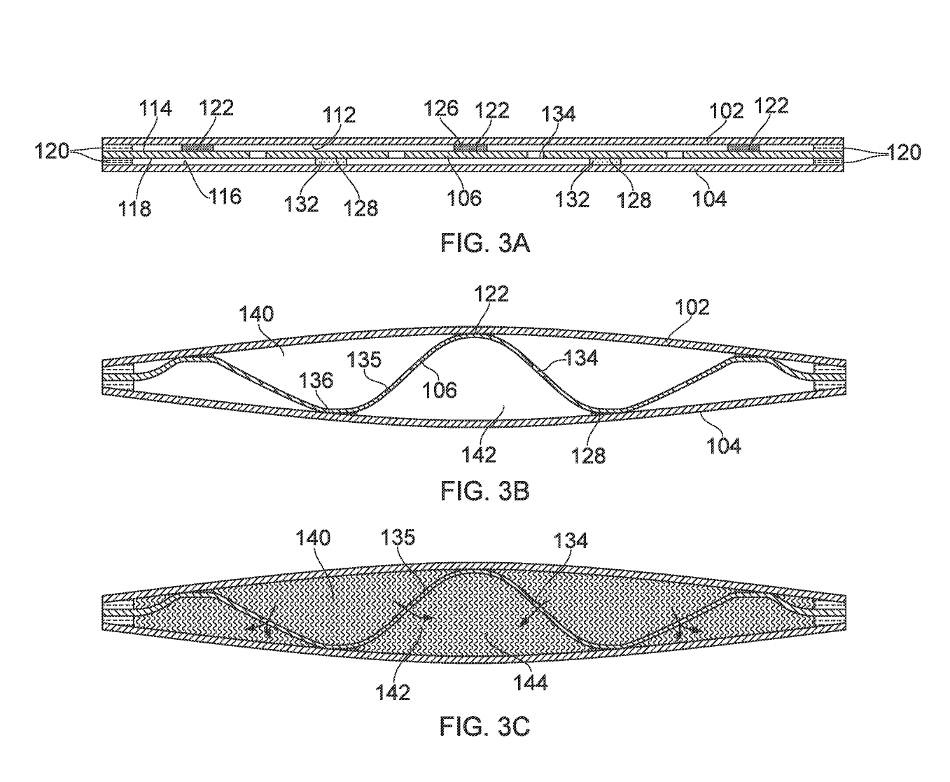

FIGS. 3A, 3B, and 3C each show a cross-sectional view on the line C through the blade 100 at different stages during its manufacture. Accordingly, an exemplary method of manufacturing the blade 100 will now be described with reference to FIGS. 2, and 3A-C.

As will be described below, the shape of the blade 100 is formed by blow moulding. FIG. 3A shows the blade 100 prior to a blow moulding step, when the outer layers 102,104 are generally parallel. Referring to FIGS. 2 and 3A initially, it will be seen that the blade 100 comprises a first outer layer 102 and a second outer layer 104.

Between the outer layers 102,104, an intermediate layer 106 is formed. In this example, the intermediate layer 106 is shown as being substantially the same thickness as the outer layers 102,104, but in other example, the intermediate layer 106 may be thinner or thicker than the outer layers 102, 104. The outer layers 102,104 are formed of the same material, and the intermediate layer 106 is formed of a different material, such as titanium. However, in other examples, the intermediate layer 106 may be formed of the same material as the outer layers 102,104.

Adjacent the periphery 108 of the blade 100 (and thus at the peripheries of the outer 102,104 and intermediate 106 layers), a peripheral sealing area 110 is defined having a substantially constant width. Within this peripheral sealing area, the outer layers 102,104 and the intermediate layer 106 are attached together about their entire peripheries. In particular, an inner surface 112 of the first outer layer 102 is bonded to a first surface 114 of the intermediate layer 106, and an inner surface 116 of the second outer layer 104 is bonded to a second surface 118 of the intermediate layer 106 (which opposes the first surface 114 of the intermediate layer 106). Accordingly, it can be seen that the first outer surface 104 is attached and sealed to the first (i.e. upper) surface 114 of the intermediate layer 106, and the second outer surface 104 is attached and sealed to the second (i.e. lower surface) 118 of the intermediate layer. Thus, peripheral bonds 120 are formed between the outer layers 120,104 and the intermediate layer 106 about the entire periphery of the blade as representatively illustrated in FIG. 2.

Still referring to FIG. 3A, the outer layers 102,104 are also attached to the intermediate layer 106 at other locations.

The first outer layer 102 is attached to the intermediate layer 106 at a first two-dimensional array of attachment areas 122 which are formed on the first surface 114 of the intermediate layer 106. As shown in the schematic transparent view of FIG. 2, the first array of attachment areas 122 are arranged in a grid-like formation across the first surface 114 of the intermediate layer 106 defining a diamond or square 124 between each four attachment areas 122. Accordingly, each of the attachment areas 122 is equally spaced from the other attachment areas 122 which form the first array of attachment areas 122. The first array of attachment areas 122 is therefore formed as a plurality of columns and rows, which each extend in a different direction across the blade 100. In this example, the attachment areas 122 of the intermediate layer 106 are diffusion bonded to the first outer layer 102 to form diffusion bonds 126 between the outer layer 102 and the intermediate layer.

Similarly, the second outer layer 104 is attached to the intermediate layer 106 at a second two dimensional array of attachment areas 128. As shown in the schematic transparent view of FIG. 2, the second array of attachment areas 128 are arranged in a substantially similar manner to the first array. In particular, the second array of attachment areas are in a grid-like formation across the second surface 118 intermediate layer 106 defining a diamond or square 130 between each four attachment areas 128. Accordingly, each of the attachment areas 128 is equally spaced from the other attachment areas 128 which form the first array of attachment areas 128. In this example, the attachment areas 128 of the intermediate layer 106 are diffusion bonded to the second outer layer 104 to form diffusion bonds 132 between the outer layer 104 and the intermediate layer 106.

In order to easily distinguish between the two arrays of attachment areas 122, 128 in the Figures, the first array of attachment areas 122 are shown in dark shading, and the second array of attachment areas 128 are shown in light shading. However, it should be understood that the form of the attachment areas 122,128 and the bonds 126,130 may be substantially identical, apart from that they are formed on opposite sides of the intermediate layer 106.

In FIG. 2, each of the layers 102,204,106 is shown transparent so the relative arrangement of the attachment areas 122,128 in plan view can be seen. For illustrative purposes, the size and spacing of the attachment areas 122,128 is exaggerated in FIGS. 2, 3A-C and the number of attachment areas 122,128 is reduced in order that the manufacture and structure of the blade 100 can be easily understood. Accordingly, while these Figures show five attachment areas 122,128 across the width of the blade 100 and ten attachment areas along the length of the blade 100, it will be understood that in other examples, a far greater number of attachment areas 122,128 will be provided, which are both smaller and more closely spaced.

As can be seen in FIG. 2, apart from attachment areas 122 formed at the edge of the grid, each attachment area 122 in the first array is generally arranged at the centre of a square or diamond 130 formed by four of the second array of attachment areas 128. Likewise, each attachment area 128 in the second array is generally arranged at the centre of a square or diamond 124 formed by four of the first array of attachment areas 124. Thus, each attachment area 122 at which the intermediate layer 106 is attached to the first outer layer 102 is surrounded by attachment areas 128 at which the intermediate layer 106 is attached to the second outer layer 104. Conversely, each attachment area 128 at which the intermediate layer 106 is attached to the second outer layer 104 is surrounded by attachment areas 121 at which the intermediate layer 106 is attached to the first outer layer 102.

As can also be seen in FIGS. 2 and 3A-C, the intermediate layer 106 further comprises a plurality of apertures 134 which extend through the entire thickness of the intermediate layer 106. As shown in FIG. 2, each of the apertures 134 is formed at a mid-point between adjacent attachment areas 122,128.

Once the relevant bonds 120,126 and 132 have been made between the outer layers 102,104, and the intermediate layer 106, the blade 100 is ready to be formed into its finished shape. In order to achieve this, the separation between the first and second outer layers 102, 104 is increased by blow moulding the blade 100. The blade 100 as shown in FIG. 3A is arranged in a mould and an opening is provided (not shown) through which high pressure gas is forced into the interior of the blade 100. The outer layers 102,104 are then forced outwardly to conform to the mould. After this blow moulding process, the blade 100 may appear as shown in FIG. 3B.

As can be seen in FIG. 3B, the separation between the outer layers 102,104 has been substantially increased across the entire area of the blade 100. The attachment areas 122 of the intermediate layer 106 were attached to the first outer layer 102, and therefore, as the first outer layer 102 was increasingly separated from the second outer layer 104, the portion of the intermediate layer 106 proximate each attachment area 122 has been deformed away from the second outer layer 104. Likewise, as each of the attachment areas 128 of the intermediate layer 106 were attached to the second outer layer 104, when the second outer layer 104 was increasingly separated from the first outer layer 102, the portion of the intermediate layer 106 proximate each attachment area 128 has been deformed away from the first outer layer 102.

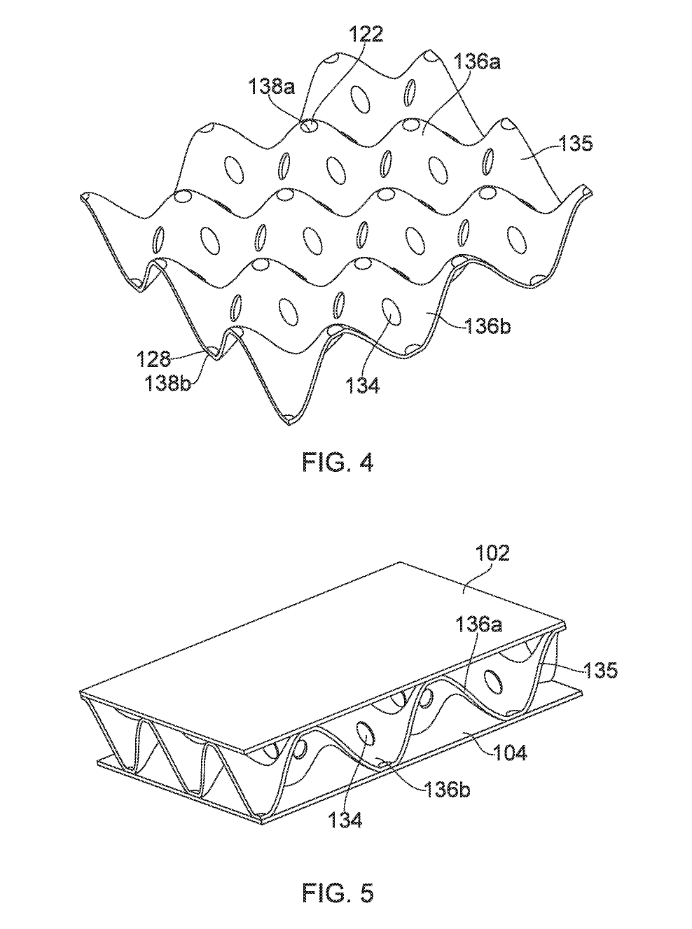

Therefore, the intermediate layer 106 has been deformed into a corrugated structure 135. This corrugated structure 135 is shown in more detail and more accurately in FIGS. 4 and 5, which respectively show a cutaway section of the corrugated structure 135, and of the blade 100 after blow moulding respectively. As the first and second arrays of attachment areas 122,128 extend in two dimensions across the blade, the corrugated structure 135 is generally formed of a plurality of corrugations in the form of opposing cone-like (or dome-like) structures 136 which have their peaks 138 arranged at the attachment areas 122,128.

For clarity, corrugations having their peak at an attachment area 122 from the first array will be referred to as upper cones 136a and peaks 138a, and corrugations having their peak at an attachment area 128 from the second array will be referred to as lower cones 136b and troughs 138b. Of course, upper and lower in this context should be understood to merely indicate that the cones 136a,b are facing in opposing directions, and not imply that the cones 136a,b must be faced up or down, or in any other particular orientation relative to the earth.

As can be seen more clearly in FIGS. 4 and 5, the corrugated structure 135 generally has an egg-box shaped appearance due to the opposing cone-like structures 136. Owing to the reduced number of attachment areas 122,128 depicted in FIGS. 2 and 3A-C, the corrugated structure 135 shown in FIG. 3B only shows five cone-like structures 136 across the width of the blade 100, each structure 136 having a different height. However, a far greater number of uniformly shaped cone-like structures 136 may be formed across the blade 100 in some examples like that of FIGS. 4 and 5. Furthermore, the separation between the outer layers 102,104 in FIGS. 3B and 3C may be exaggerated. In some cases, a separation between the first and second layers 102,104 may be increased, but also substantially constant across the blade 100, for example, as shown in FIG. 5.

In some specific examples, the relative ratio of the aperture 134 diameter and the cone height may be 1:3 or 1:4, as these may provide an particularly optimised balance between weight and structural strength and stiffness, and also provide particularly good interconnectivity between the corrugations while also sufficiently inhibiting movement of filling material in use.

The corrugated structure 135 provides greatly improved strength and stiffness of the blade 100 compared to a blade having no intermediate layer or corrugated structure. However, the blade 100 may also be considerably lighter than an equivalent blade having a solid structure or other types of reinforcement, such as webs or ribs. The cone-like structures 136 of the corrugated structure 135 in particular may be highly resistant to buckling.

Furthermore, the corrugated structure 135 is essentially self-forming during manufacture after the intermediate layer 106 has been appropriately bonded to the outer layers 102,104. Accordingly, it may be far easier and cheaper to manufacture than other methods, such as milling or etching an internal structure.

It will be understood that, due to the deformation of the intermediate layer 106 into the corrugated structure 135, an enclosed volume is now formed within the blade 100, which is comprised of a first volume 140 formed between the intermediate layer 106/corrugated structure 135 and the first outer layer 102, and a second volume 142 formed between the intermediate layer 106/corrugated structure 135 and the second outer layer 104. It will be understood that, generally, the first volume 140 is defined by the ‘interiors’ of the lower cone-like structures 136b, and the second volume is defined by the ‘interiors’ of the upper cone-like structures 136a.

The apertures 134, which were equally spaced between the attachment areas 122,128 in plan view, are now arranged on the sloped sections of cone-like structures 136. Accordingly, the apertures 134 provide communication between the first and second volumes 140,142 within the blade 100. Furthermore, the apertures 134 also lighten the corrugated structure 135, which is a key concern in aerospace technology in particular.

Referring now to FIG. 3C, the blade 100 of FIG. 3B has now been filled with a filling material 144. In order to fill the blade 100, one or more inlet openings are formed in the first outer layer 102 (not shown), and one or more outlet openings are formed in the second outer layer 104. It should be understood that the inlet and outlet openings could also be formed in other locations.

The filling material 144, which is a viscous damping filler 144, is then forced into the first volume 140 between the corrugated structure 135 and the first outer layer 102 via the inlet openings. Once inside the blade 100, the filling material 144 can pass through the apertures 134 and into the second volume 144 as shown by the arrows in FIG. 3C. Once both the first and second volumes 142,144 are filled with filling material 144, the material 144 will begin to be expelled via the outlet openings in the second outer layer 104. At this point, the inlet and outlet openings can be sealed, thereby sealing the internal volume of the blade 100 full of filing material 144. In some cases, the filling material 144 may subsequently set to a flexible solid, or may increase its viscosity to become a gel. In some examples, apertures 134 may not be provided, and the filling material 144 and separate inlet and outlet openings may be provided for each of the first and second volumes 140,142.

The corrugated structure 135 now provides a further advantage in that it constrains the filling material 144 in position within the blade 100. When the blade 100 is rotating on a disk, for example, within a gas turbine engine, the centrifugal force may tend to urge the filling material 144 towards the radially outer end of the blade 100. However, the corrugated structure 135 traps the filling material 144 between its corrugations, thereby preventing it from moving significant distances within the blade 100 and generating extreme hydrostatic pressures which may damage the blade 100 in use. Accordingly, filling material 144 remains distributed along the blade 100 during use, and improves the damping provided in the blade 100.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method of forming a blade or vane for a gas turbine engine comprising:
attaching a first outer layer to a first two-dimensional array of attachment areas on a first surface of an intermediate layer;
attaching a second outer layer to a second two-dimensional array of attachment areas on a second surface of the intermediate layer opposite the first surface; and
increasing a separation between at least a portion of the first and second outer layer to thereby deform the intermediate layer into a corrugated structure having corrugations in first and second directions.

2. A method as claimed in claim 1, wherein the attachment areas are substantially point-like.

3. A method as claimed in claim 1, wherein each of the first array of attachment areas and the second array of attachment areas are substantially equally spaced across the first and second surfaces of the intermediate layer.

4. A method as claimed in claim 3, wherein each of the first array of attachment areas and the second array of attachment areas are formed as a square array.

5. A method as claimed in claim 4, wherein one or more of the attachment areas of the first array of attachment areas is arranged substantially at the centre of a square defined by four of the second array of attachment areas, and one or more of the attachment areas of the second array of attachment areas is arranged substantially at the centre of a square defined by four of the first array of attachment areas.

6. A method as claimed in claim 1, further comprising filling an internal volume formed within the component with a filling material.

7. A method as claimed in claim 6, wherein the internal volume comprises a first volume formed between the first outer layer and the corrugated structure, and a second volume formed between the second outer later and the corrugated structure.

8. A method as claimed in claim 6, wherein the intermediate layer further comprises one or more apertures formed therethrough, and wherein optionally the one or more apertures have a size which that is less than or equal to one third of a height of the corrugations.

9. A method as claimed in claim 7 wherein the intermediate layer further comprises one or more apertures formed there through, and wherein the filling comprises filling one of the first and second volumes directly and filling the other of the first and second volumes from through the one or more apertures in the intermediate layer.

10. A method as claimed in claim 1, wherein the first and second arrays of attachment areas are arranged such that the corrugations of the corrugated structure comprise alternating cone-like or dome-like structures having peaks formed at the attachment areas, and wherein optionally the first and second arrays of attachment areas are arranged such that the corrugated structure has an egg-box-like shape.

11. A method as claimed in claim 1, wherein the attaching comprises diffusion bonding the first and second arrays of attachment areas to the first and second outer layers respectively, and wherein optionally the intermediate layer is attached to the first and second outer layers about a periphery of the intermediate layer.

12. A method as claimed in claim 1, wherein increasing the separation comprises blow-moulding the blade or vane.

13. A blade or vane for a gas turbine engine comprising:
a first outer layer;
a second outer layer; and
a corrugated structure formed between the first and second outer layers, the corrugated structure being attached to the first outer layer at a first two-dimensional array of attachment areas and attached to the second outer layer at a second two-dimensional array of attachment areas such that corrugations of the corrugated structure extend in two directions.

14. A blade or vane as claimed in claim 13, wherein the corrugations of the corrugated structure comprise alternating cone-like dome-like structures having peaks formed at the attachment areas, and wherein optionally the corrugated structure has an egg-box-like shape.

15. A blade or vane as claimed in claim 13, further comprising a filling material provided in an internal volume of the blade or vane between the first and second outer layers and the corrugated structure.

16. A blade or vane as claimed in claim 13, wherein the corrugated structure has one or more apertures formed there through, and wherein optionally the one or more apertures have a size which is around one third of a height of the corrugations.

17. A rotor for a gas turbine engine comprising one or more blades as claimed in claim 13.

18. A bladed disc for a gas turbine engine comprising one or more blades as claimed in claim 13.

19. A gas turbine engine comprising one or more blades as claimed in claim 13.

20. A method of manufacturing a gas turbine engine comprising forming a blade or vane using the method according to claim 1.
